(19) United States
(12) Patent Application Publication
(10) Pub. No.: US 2005/0031818 A1
(43) Pub. Date: Feb. 10, 2005

(54) Polyamide-based multilayer tube for transferring fluids

(76) Inventor: Sebastien Micheneau, Courbevoie (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/875,123

(22) Filed: Jun. 23, 2004

Related U.S. Application Data
(60) Provisional application No. 60/508,967, filed on Oct. 6, 2003.

(30) Foreign Application Priority Data
Jul. 8, 2003 (FR) 03.08315

(51) Int. Cl. B32B 1/08; B32B 27/08; B32B 27/34; B32B 27/32

(52) U.S. Cl. 428/36.91; 428/475.8; 428/476.1

(57) ABSTRACT

The present invention relates to a multilayer tube comprising, in its radial direction from the outside inwards:
an outer layer (1) made of a polyamide chosen from PA-11, PA-12, aliphatic polyamides resulting from the condensation of an aliphatic diamine having from 6 to 12 carbon atoms and of an aliphatic diacide having from 9 to 12 carbon atoms, and 11/12 copolyamides having either more than 90% of 11 units or more than 90% of 12 units; a tie layer;
a layer (2) made of a polyamide (A)/polyolefin (B) blend (2) having a polyamide matrix; a tie layer;
an inner layer (3) made of a polyamide that is chosen from the same products as the outer layer and may be identical or different; the layers being successive and adhering to one another in their respective contact zones.

This application claims benefit, under U.S.C. §119(a) of French National Applications Number 03.08315, filed Jul. 8, 2003; and also claims benefit, under U.S.C. § 119(e) of U.S. provisional application 60/508,967, filed Oct. 6, 2003.

### FIELD OF THE INVENTION

The present invention relates to polyamide-based tubes for transferring fluids.

As an example of tubes for transferring fluids, mention may be made of tubes for petrol, and in particular for conveying petrol from the tank to the engine of motor vehicles. As other examples of transfer of fluids, mentioned may be made of the fluids used in fuel cells, CO₂-based systems for cooling and conditioned air, hydraulic systems, cooling circuits, conditioned air and medium-pressure power transfer systems.

For safety and environmental protection reasons, motor-vehicle manufacturers require these tubes to have both mechanical properties such as strength and flexibility with good cold (−40° C.) impact strength as well as good high-temperature (125° C.) strength, and also very low permeability to hydrocarbons and to their additives, particularly alcohols such as methanol and ethanol. These tubes must also have good resistance to the fuels and lubrication oils for the engine. These tubes are manufactured by coextruding the various layers using standard techniques for thermoplastics.

The invention is particularly useful for transporting petrol.

### BACKGROUND OF THE INVENTION

Among the characteristics of the specification for these petrol tubes, five are particularly difficult to obtain jointly in a simple manner:
cold (−40° C.) impact strength—the tube does not break;
fuel resistance;
high-temperature (125° C.) strength;
very low permeability to petrol;
good dimensional stability of the tube in use with the petrol.

In multilayer tubes of various structures, the cold impact strength remains unpredictable before having carried out the standardized tests for cold impact strength.

Moreover, it is already known from patent application U.S. Pat. No. 5,916,945 that in motor vehicles, owing to the effect of the injection pump, the petrol flows at high speed in the pipes connecting the engine to the tank. In certain cases, friction between the petrol and the internal wall of the tube can generate electrostatic charges, the build-up of which may result in an electrical discharge (a spark) capable of igniting the petrol with catastrophic consequences (an explosion). It is therefore necessary to limit the surface resistivity of the internal face of the tube to a value of generally less than 10⁶ ohms. It is known to lower the surface resistivity of polymeric resins or materials by incorporating conductive and/or semiconductive materials into them, such as carbon black, carbon nanotubes, steel fibres, carbon fibres and particles (fibres, platelets or spheres) metallized with gold, silver or nickel.

Among these materials, carbon black is more particularly used, for economic and processability reasons. Apart from its particular electrically conductive properties, carbon black behaves as a filler such as, for example, talc, chalk or kaolin. Thus, those skilled in the art know that when the filler content increases, the viscosity of the polymer/filler blend increases. Likewise, when the filler content increases, the flexural modulus of the filled polymer increases. These known and predictable phenomena are explained in “Handbook of Fillers and Reinforcements for Plastics”, edited by H. S. Katz and J. V. Milewski—Van Nostrand Reinhold Company—ISBN 0-442-25372-9, see in particular Chapter 2, Section II for fillers in general and Chapter 16, Section VI for carbon black in particular.

As regards the electrical properties of carbon black, the technical report “Ketjenblack EC—BLACK 94/01” by Akzo Nobel indicates that the resistivity of the formulation drops very suddenly when a critical carbon black content, called the percolation threshold, is reached. When the carbon black content increases further, the resistivity rapidly decreases until reaching a stable level (plateau region). It is therefore preferred, for a given resin, to operate in the plateau region in which a metering error will have only a slight effect on the resistivity of the compound.

Polyamide- and EVOH-based tubes for transporting petrol are also known from patent application U.S. Pat. No. 6,177,162. These tubes may have a four-layer structure comprising, respectively, a PA-12 outer layer, a tie layer, which is a grafted polyolefin, an EVOH layer and an inner layer in contact with the petrol, comprising a blend of a polyamide and a polyolefin having a polyamide matrix.

Patent U.S. Pat. No. 5,076,329 discloses a three-layer tube comprising, respectively, a PA-12 outer layer, a tie layer which is a grafted polyolefin and an EVOH inner layer in contact with the petrol.

Patents U.S. Pat. No. 5,167,259 and EP 470 606 disclose a five-layer tube comprising, respectively, a PA-12 outer layer, a tie layer which is a grafted polyolefin, a PA-6 layer, an EVOH layer and a PA-6 inner layer in contact with the petrol.

Patent U.S. Pat. No. 5,038,833 discloses a three-layer tube comprising, respectively, a PA-12 outer layer, an EVOH layer and a PA-12 inner layer in contact with the petrol.

All these tubes have good properties but the thickness of the tie layers is not easy to control and as a result, there may be delaminations. In the tube described in U.S. Pat. No. 5,038,833, there is no tie but delaminations do occur.

Patent US 2002155242 discloses a tube for transferring fluids, in particular petrol. It comprises, respectively, a polyamide outer layer, a copolyamide tie layer, an EVOH layer, another copolyamide tie layer and a polyamide inner layer in contact with the petrol.

It has now been found that, by replacing, in the above tube, the EVOH layer with a layer made of a polyamide/polyolefin blend having a polyamide matrix, the mechanical strength of the tube is improved. This is particularly beneficial if the inner layer contains a conductor in order to make it antistatic. This is because it is known that a layer containing a filler such as carbon black is more rigid and has a lower impact strength that the same layer not containing this filler. Replacing the EVOH with a polyamide/polyolefin blend having a polyamide matrix makes it possible to improve the impact strength. However, depending on the nature of the fluid transported, this tube may be less of a barrier than that disclosed in US 2002155242.

### SUMMARY OF THE INVENTION

The present invention relates to a multilayer tube comprising, in its radial direction from the outside inwards:
an outer layer (1) made of a polyamide chosen from PA-11, PA-12, aliphatic polyamides resulting from the condensation of an aliphatic diamine having from 6 to 12 carbon atoms and of an aliphatic diacide having from 9 to 12 carbon atoms, and 11/12 copolyamides having either more than 90% of 11 units or more than 90% of 12 units;
a tie layer;
a layer (2) made of a polyamide (A)/polyolefin (B) blend (2) having a polyamide matrix;
a tie layer;
an inner layer (3) made of a polyamide that is chosen from the same products as the outer layer and may be identical or different;
the layers being successive and adhering to one another in their respective contact zones.

According to one embodiment of the invention, the inner layer contains an electrically conducting material, producing a surface resistivity of less than 10⁶ Ω.

According to another embodiment of the invention, the inner layer (3) contains essentially no electrically conducting material and the tube includes a layer (3a) that adheres to the layer (3), this layer is made of a polyamide and contains an electrically conducting material producing a surface resistivity of less than 10⁶ Ω.

These tubes may have an outside diameter of 6 to 110 mm and a thickness of around 0.5 to 5 mm.

Advantageously, the tube for petrol according to the invention has an outside diameter ranging from 6 to 12 mm and a total thickness of 0.22 mm to 2.5 mm comprising:
a thickness of 50 to 700 μm for the outer layer (1);
a thickness of 10 to 150 μm for the tie layers;
a thickness of 50 to 1000 μm for the layer made of a polyamide/polyolefin blend having a polyamide matrix; and
a thickness of 50 to 500 μm for the inner layer (3) or for the combination of layers (3) and (3a).

The tube of the present invention has a very low permeability to petrol, particularly to hydrocarbons and to their additives, particularly alcohols such as methanol and ethanol, or else ethers such as MTBE or ETBE. These tubes also exhibit good resistance to fuel and lubrication oils for the engine.

This tube exhibits very good mechanical properties at low or high temperature.

The tube of the invention may include an additional layer formed from manufacturing scrap or from tubes of the invention that have defects, this scrap or these tubes being ground and then melted and coextruded with the other layers. This layer may lie between the outer layer and the tie layer.

The invention also relates to the use of these tubes for transporting petrol.

### DETAILED DESCRIPTION OF THE INVENTION

As regards the outer layer, the polyamides advantageously have a number-average molecular mass \overline{M}ₙ generally greater than or equal to 12 000 and advantageously between 15 000 and 50 000. Their weight-average molecular mass \overline{M}_{w} is generally greater than 24 000 and advantageously between 30 000 and 100 000. Their inherent viscosity (measured at 20° C. for a specimen consisting of 5×10⁻³ g per cm³ of meta-cresol) is in general greater than 0.9.

As examples of aliphatic polyamides resulting from the condensation of an aliphatic diamine having from 6 to 12 carbon atoms and an aliphatic diacid having from 9 to 12 carbon atoms, mention may be made of:
PA-6,12, resulting from the condensation of hexamethylene diamine and 1,12-dodecanedioic acid;
PA-9,12, resulting from the condensation of the C₉ diamine and 1,12-dodecanedioic acid;
PA-10,10, resulting from the condensation of the C₁₀ diamine and 1,10-decanedioic acid; and
PA-10,12, resulting from the condensation of the C₁₀ diamine and 1,12-dodecanedioic acid.

As regards the 11/12 copolyamides having either more than 90% of 11 units or more than 90% of 12 units, these result from the condensation of 1-aminoundecanoic acid with lauryllactam (or the C₁₂ alpha, omega-amino acid).

Advantageously, the polyamide contains an organic or mineral catalyst which is added during the polycondensation. Preferably, this is phosphoric or hypophosphoric acid. The amount of catalyst may be up to 3000 ppm, and advantageously between 50 and 1000 ppm, relative to the amount of polyamide.

It would not be outside the scope of the invention to use a blend of polyamides.

Advantageously, the polyamide is PA-11 or PA-12.

The polyamide may be plasticized. As regards plasticizers, these are chosen from benzene suiphonamide derivatives, such as N-butyl benzenesulphonamide (BBSA), ethyl toluene sulphonamide or N-cyclohexyl toluene sulphonamide; esters of hydroxybenzoic acids, such as 2-ethylhexyl-para-hydroxybenzoate and 2-decylhexyl-para-hydroxy-benzoate; esters or ethers of tetrahydrofurfuryl alcohol, like oligoethyleneoxytetra-hydrofurfuryl alcohol; esters of citric acid and of hydroxy malonic acid such as oligoethyleneoxy malonate; and copolymers comprising polyamide blocks and polyether blocks. A particularly preferred plasticizier is N-butyl benzene sulphonamide (BBSA).

Copolymers having polyamide blocks and polyether blocks result from the copolycondensation of polyamide blocks having reactive ends with polyether blocks having reactive ends, such as, inter alia:
1) polyamide blocks having diamine chain ends with polyoxyalkylene blocks having dicarboxylic chain ends;
2) polyamide blocks having dicarboxylic chain ends with polyoxyalkylene blocks having diamine chain ends, obtained by cyanoethylation and hydrogenation of aliphatic dihydroxylated alpha, omega-polyoxyalkylene blocks called polyetherdiols;
3) polyamide blocks having dicarboxylic chain ends with polyetherdiols, the products obtained being, in this particular case, polyetheresteramides. Advantageously, these copolymers are used.

Polyamide blocks having dicarboxylic chain ends derive, for example, from the condensation of alpha, omega-aminocarboxylic acids, of lactams or of dicarboxylic acids and diamines in the presence of a chain-stopping dicarboxylic acid.

Polyamide blocks having diamine chain ends derive, for example, from the condensation of alpha, omega-aminocarboxylic acids, of lactams or of dicarboxylic acids and diamines in the presence of a chain-stopping diamine.

The polyether may, for example, be a polyethylene glycol (PEG), a polypropylene glycol (PPG) or a polytetramethylene glycol (PTMG). The latter is also called polytetrahydrofuran (PTHF).

The number-average molar mass \overline{M}ₙ of the polyamide blocks is between 300 and 15 000 and preferably between 600 and 5000. The mass \overline{M}ₙ of the polyether blocks is between 100 and 6000 and preferably between 200 and 3000.

Polymers having polyamide blocks and polyether blocks may also include randomly distributed units. These polymers may be prepared by the simultaneous reaction of the polyether and polyamide-block precursors.

For example, it is possible to react polyetherdiol, a lactam (or an alpha, omega-amino acid) and a chain-stopping diacid in the presence of a small amount of water. A polymer is obtained having essentially polyether blocks and polyamide blocks of very variable length, but also the various reactants, having reacted in a random fashion, which are distributed randomly along the polymer chain.

The polyetherdiol blocks are either used as such and copolycondensed with polyamide blocks having carboxylic ends or they are aminated in order to be converted into diamine polyethers and condensed with polyamide blocks having carboxylic ends. They may also be mixed with polyamide precursors and a chain stopper in order to make polyamide-block polyether-block polymers having randomly distributed units.

Polymers having polyamide and polyether blocks are described in patents U.S. Pat. No. 4,331,786, U.S. Pat. No. 4,115,475, U.S. Pat. No. 4,195,015, U.S. Pat. No. 4,839,441, U.S. Pat. No. 4,864,014, U.S. Pat. No. 4,230,838 and U.S. Pat. No. 4,332,920.

The ratio of the amount of copolymer having polyamide blocks and polyether blocks to the amount of polyamide is, by weight, advantageously between 10/90 and 60/40. Mention may also be made, for example, of copolymers having PA-6 blocks and PTMG blocks and copolymers having PA-12 blocks and PTMG blocks.

Preferably, nylon-12 is used. Advantageously, the polyamide of the outer layer is plasticized by standard plasticizers such as N-butyl benzene sulphonamide (BBSA) and copolymers comprising polyamides blocks and polyether blocks.

It would not be outside the scope of the invention to use a mixture of plasticizers. The plasticizer may be introduced into the polyamide during the polycondensation or later. The proportion of plasticizer may be from 0 to 30% by weight per 100 to 70% of polyamide respectively, and advantageously 5 to 20%.

As regards the tie, this denotes any product that allows adhesion of the layers. The tie may be a functionalized polyolefin carrying, for example, a carboxylic acid or carboxylic acid anhydride functional group. It may be blended with an unfunctionalized polyolefin. The tie may also be a copolyamide.

To simplify matters, functionalized polyolefins (B1) and unfunctionalized polyolefins (B2) will be described later.

As a first example of a tie, mention may be made of the blends comprising:
5 to 30 parts of a polymer (D) which itself comprises a blend of a polyethylene (D1) having a density of between 0.910 and 0.940 and a polymer (D2) chosen from elastomers, very low-density polyethylenes and metallocene polyethylenes, the blend (D1)+(D2) being cografted by an unsaturated carboxylic acid;
95 to 70 parts of a polyethylene (E) having a density of between 0.910 and 0.930;
the blend of (D) and (E) being such that:
   its density is between 0.910 and 0.930,
   the content of grafted unsaturated carboxylic acid is between 30 and 10 000 ppm and
   the MFI (ASTM D 1238: 190° C./2.16 kg) is between 0.1 and 3 g/10 min, where MFI denotes the melt flow index.

The density of the tie is advantageously between 0.915 and 0.920. Advantageously, (D1) and (E) are LLDPEs; preferably, they have the same comonomer. This comonomer may be chosen from 1-hexene, 1-octene and 1-butene. The unsaturated carboxylic acid may be replaced with an unsaturated carboxylic acid anhydride.

As a second example of a tie, mention may be made of the following blends comprising:
5 to 30 parts of a polymer (F) which itself comprises a blend of a polyethylene (F1) having a density of between 0.935 and 0.980 and a polymer (F2) chosen from elastomers, very low-density polyethylenes and ethylene copolymers, the blend (F1)+(F2) being cografted by an unsaturated carboxylic acid;
95 to 70 parts of a polyethylene (G) having a density of between 0.930 and 0.950;
the blend of (F) and (G) being such that:
   its density is between 0.930 and 0.950 and advantageously between 0.930 and 0.940,
   the content of grafted unsaturated carboxylic acid is between 30 and 10 000 ppm and
   the MFI (melt flow index) measured according to ASTM D 1238 is between 5 and 100 (at 190° C./21.6 kg).

The unsaturated carboxylic acid may be replaced with an unsaturated carboxylic acid anhydride.

As a third example of a tie, mention may be made of blends consisting of an HDPE-, LLDPE-, VLDPE- or LDPE-type polyethylene, 5 to 35% of a grafted metallocene polyethylene (grafted by an unsaturated carboxylic acid or an unsaturated carboxylic acid anhydride), and 0 to 35% of an elastomer, the total being 100%.

As a fourth example of a tie, mention may be made of the blends comprising:
5 to 35 parts of a polymer (S) which itself consists of a blend of 80 to 20 parts of a metallocene polyethylene (S1) having a density of between 0.865 and 0.915 and 20 to 80 parts of a non-metallocene LLDPE polyethylene (S2), the blend (S1)+(S2) being cografted by an unsaturated carboxylic acid;
95 to 65 parts of a polyethylene (T) chosen from polyethylene homopolymers or copolymers, and elastomers;
the blend of (S) and (T) being such that:
   the content of grafted unsaturated carboxylic acid is between 30 and 100 000 ppm and
   the MFI (ASTMD 1238: 190° C./2.16 kg) is between 0.1 and 10 g/10 min, where MFI denotes the melt flow index and is expressed in grams per 10 minutes.

The unsaturated carboxylic acid may be replaced with an unsaturated carboxylic acid anhydride.

With regard to the copolyamide-type tie layers, the copolyamides that can be used in the present invention have a melting point (DIN 53736B standard) of between 60 and 200° C. and their relative solution viscosity can be between 1.3 and 2.2 (DIN 53727 standard; m-cresol solvent, 0.5 g/100 ml concentration, 25° C. temperature, Ubbelohde viscometer). Their melt rheology is preferably similar to that of the materials of the outer and inner layers.

The copolyamides derive, for example, from the condensation of alpha,omega-aminocarboxylic acids, of lactams or of dicarboxylic acids and diamines.

According to a first type, the copolyamides result from the condensation of at least two alpha,omega-aminocarboxylic acids or of at least two lactams having from 6 to 12 carbon atoms or of a lactam and of an aminocarboxylic acid not having the same number of carbon atoms, in the possible presence of a chain stopper which may, for example, be a monoamine or a diamine or a monocarboxylic acid or a dicarboxylic acid. Among chain stoppers, mention may be made in particular of adipic acid, azelaic acid, stearic acid and dodecanediamine. The copolyamides of this first type may also include units which are residues of diamines and dicarboxylic acids.

By way of examples of dicarboxylic acids, mention may be made of adipic acid, nonanedioic acid, sebacic acid and dodecanedioic acid.

By way of examples of alpha,omega-aminocarboxylic acids, mention may be made of aminocaproic acid, aminoundecanoic acid and aminododecanoic acid.

By way of examples of lactams, mention may be made of caprolactam and lauryllactam (2-azacyclotridecanone).

According to a second type, the copolyamides result from the condensation of at least one alpha,omega-aminocarboxylic acid (or a lactam), at least one diamine and at least one dicarboxylic acid. The alpha,omega-aminocarboxylic acid, the lactam and the dicarboxylic acid may be chosen from those mentioned above.

The diamine may be a branched, linear or cyclic aliphatic diamine or else an aryl-type diamine.

By way of examples, mention may be made of hexamethylenediamine, piperazine, isophoronediamine (IPD), methylpentamethylenediamine (MPDM), bis(amino-cyclohexyl)methane (BACM) and bis(3-methyl-4-aminocyclohexyl)methane (BMACM).

The manufacturing processes for copolyamides are known from the prior art and these copolyamides may be manufactured by polycondensation, for example in an autoclave.

According to a third type, the copolyamides are a blend of a 6/12 copolyamide rich in 6 and of a 6/12 copolyamide rich in 12. With regard to the blend of 6/12 copolyamides, one comprising by weight more 6 than 12 and the other more 12 than 6, the 6/12 copolyamide results from the condensation of caprolactam with lauryllactam. It is clear that “6” denotes units derived from caprolactam and “12” denotes units derived from lauryllactam. It would not be outside the scope of the invention if the caprolactam were to be replaced completely or partly with amincaproic acid, and likewise the lauryllactam may be replaced with aminododecanoic acid. These copolyamides may include other units, provided that the ratios of the 6 and 12 portions are respected.

Advantageously, a 6-rich copolyamide comprises 60 to 90% by weight of 6 per 40 to 10% of 12, respectively.

Advantageously, the 12-rich copolyamide comprises 60 to 90% by weight of 12 per 40 to 10% of 6, respectively.

As regards the proportions of the 6-rich copolyamide and of the 12-rich copolyamide, these may be, by weight, from 40/60 to 60/40, and preferably 50/50.

These copolyamide blends may also include up to 30 parts by weight of other grafted polyolefins or (co)polyamides per 100 parts of 6-rich and 12-rich copolyamides.

These copolyamides have a melting point (DIN 53736 B standard) of between 60 and 200° C. and their relative solution viscosity maybe between 1.3 and 2.2 (DIN 53727 standard m-cresol solvent, 0.5 g/100 ml concentration, 25° C., Ubbelohde viscometer).

Their melt rheology is preferably similar to that of the materials of adjacent layers.

These products are manufactured by standard techniques for polyamides. Processes are disclosed in patents U.S. Pat. No. 4,424,864, U.S. Pat. No. 4,483,975, U.S. Pat. No. 4,774,139, U.S. Pat. No. 5,459,230, U.S. Pat. No. 5,489,667, U.S. Pat. No. 5,750,232 and U.S. Pat. No. 5,254,641.

With regard to the layer (2) made of a polyamide (A)/polyolefin (B) blend having a polyamide matrix, and firstly polyamides, the term “polyamide” is understood to mean products resulting from the condensation:
of one or more amino acids, such as aminocaproic, 7-aminoheptanoic, 1-aminoundecanoic and 12-aminododecanoic acids or of one or more lactams, such as caprolactam, oenantholactam and lauryllactam;
of one or more salts or mixtures of diamines, such as hexamethylenediamine, dodecamethylenediamine, metaxylylenediamine, bis-p(aminocyclohexyl)methane and trimethylhexamethylenediamine with diacids such as isophthalic, terephthalic, adipic, azelaic, suberic, sebacic and dodecanedicarboxylic acids.

By way of examples of a polyamide, mention may be made of PA-6, PA-6,6, PA-11 and PA-12.

It also may be advantageous to use copolyamides. Mention may be made of the copolyamides resulting from the condensation of at least two alpha, omega-aminocarboxylic acids or of two lactams or of a lactam and of an alpha, omega-aminocarboxylic acid. Mention may also be made of the copolyamides resulting from the condensation of at least one alpha, omega-aminocarboxylic acid (or a lactam), at least one diamine and at least one dicarboxylic acid.

By way of examples of lactams, mention may be made of those having from 3 to 12 carbon atoms in the main ring and possibly being substituted. Mention may be made, for example, of β,β-dimethylpropriolactam, α,α-dimethylpropriolactam, amylolactam, caprolactam, capryllactam and lauryllactam.

By way of examples of alpha, omega-aminocarboxylic acids, mention may be made of aminoundecanoic acid and aminododecanoic acid. By way of examples of dicarboxylic acids, mention may be made of adipic acid, sebacic acid, isophthalic acid, butanedioic acid, 1,4-cyclohexyldicarboxylic acid, terephthalic acid, the sodium or lithium salt of sulphoisophthalic acid, dimerized fatty acids (these dimerized fatty acids have a dimer content of at least 98% and are preferably hydrogenated) and dodecanedioic acid HOOC—(CH₂)₁₀—COOH.

The diamine may be an aliphatic diamine having from 6 to 12 carbon atoms or it may be an aryl diamine and/or a saturated cyclic diamine. By way of examples, mention may be made of hexamethylenediamine, piperazine, tetramethylenediamine, octamethylenediamine, decamethylenediamine, dodecamethylenediamine, 1,5-diaminohexane, 2,2,4-trimethyl-1,6-diaminohexane, diamine polyols, isophoronediamine (IPD), methylpentamethylenediamine (MPDM), bis(aminocyclohexyl)methane (BACM) and bis(3-methyl-4 aminocyclohexyl)methane (BMACM).

By way of examples of copolyamides, mention may be made of copolymers of caprolactam and lauryllactam (PA-6/12), copolymers of caprolactam, adipic acid and hexamethylenediamine (PA-6/6,6), copolymers of caprolactam, lauryllactam, adipic acid and hexamethylenediamine (PA-6/12/6,6), copolymers of caprolactam, lauryllactam, 11-aminoundecanoic acid, azelaic acid and hexamethylenediamine (PA-6/6,9/11/12), copolymers of caprolactam, lauryllactam, 11-aminoundecanoic acid, adipic acid and hexamethylenediamine (PA-6/6,6/11/12) and copolymers of lauryllactam, azelaic acid and hexamethylenediamine (PA-6,9/12).

Advantageously, the copolyamide is chosen from PA-6/12 and PA-6/6,6.

It is possible to use polyamide blends. Advantageously, the relative viscosity of the polyamides, measured as a 1% solution in sulphuric acid at 20° C., is between 1.5 and 5.

Advantageously, the polyamide (A) is chosen from PA-6, coPA-6/6,6 and coPA-6/12, and preferably from PA-6 and coPA-6/6,6.

As regards the polyolefin of the polyamide/polyolefin blend, this may or may not be functionalized or it may be a blend of at least one functionalized polyolefin and/or at least one unfunctionalized polyolefin. To simplify matters, the polyolefin will be described as (B) and functionalized polyolefins will be described below as (B1) and unfunctionalized polyolefins as (B2).

An unfunctionalized polyolefin (B2) is conventionally a homopolymer or a copolymer of alpha-olefins or diolefins, such as, for example, ethylene, propylene, 1-butene, 1-octene and butadiene. By way of examples, mention may be made of:
polyethylene homopolymers and copolymers, particularly LDPE, HDPE, LLDPE (linear low-density polyethylene) or VLDPE (very low-density polyethylene) and metallocene polyethylene;
propylene homopolymers and copolymers;
ethylene/alpha-olefin copolymers such as ethylene/propylene copolymers; EPRs (abbreviation for ethylene-propylene rubbers); and ethylene/propylene/diene copolymers (EPDM);
styrene/ethylene-butylene/styrene block copolymers (SEBS), styrene/butadiene/styrene block copolymers (SBS), styrene/isoprene/styrene block copolymers (SIS), styrene/ethylene-propylene/styrene block copolymers (SEPS);
copolymers of ethylene with at least one product chosen from salts or esters of unsaturated carboxylic acids such as alkyl (meth)acrylate (for example methyl acrylate), or vinyl esters of saturated carboxylic acids such as vinyl acetate (EVA), the proportion of comonomer possibly being as much as 40% by weight.

The functionalized polyolefin (B1) may be an alpha-olefin polymer having reactive units (the functional groups); such reactive units are acid, anhydride or epoxy functional groups. By way of example, mention may be made of the above polyolefins (B2) which are grafted or are copolymerized or terpolymerized with unsaturated epoxides such as glycidyl (meth)acrylate, or by carboxylic acids or the corresponding salts or esters, such as (meth)acrylic acid (this possibly being completely or partially neutralized by metals such as Zn, etc.) or else with carboxylic acid anhydrides such as maleic anhydride. A functionalized polyolefin is, for example, a PE/EPR blend, the weight ratio of which may vary between wide limits, for example between 40/60 and 90/10, the said blend being cografted with an anhydride, especially maleic anhydride, with a degree of grafting, for example, of 0.01 to 5% by weight.

The functionalized polyolefin (B1) may be chosen from the following (co)polymers, grafted with maleic anhydride or glycidyl methacrylate, in which the degree of grafting is, for example, from 0.01 to 5% by weight:
PE, PP, copolymers of ethylene with propylene, butene, hexene, or octene and containing, for example, from 35 to 80% by weight of ethylene;
ethylene/alpha-olefin copolymers such as ethylene/propylene copolymers; EPRs (abbreviation for ethylene-propylene rubbers); and ethylene/propylene/diene copolymers (EPDM);
styrene/ethylene-butylene/styrene block copolymers (SEBS), styrene/butadiene/styrene block copolymers (SBS), styrene/isoprene/styrene block copolymers (SIS), styrene/ethylene-propylene/styrene block copolymers (SEPS);
ethylene/vinyl acetate copolymers (EVA), containing up to 40% by weight of vinyl acetate;
ethylene/alkyl (meth)acrylate copolymers, containing up to 40% by weight of alkyl (meth)acrylate;
ethylene/vinyl acetate (EVA)/alkyl (meth)acrylate copolymers, containing up to 40% by weight of comonomers.

The functionalized polyolefin (B1) may also be chosen from ethylene/propylene copolymers containing predominantly propylene, these being grafted with maleic anhydride and then condensed with monoaminated polyamide (or polyamide oligomer) (products described in EP-A-0 342 066).

The functionalized polyolefin (B1) may also be a copolymer or terpolymer of at least the following units: (1) ethylene, (2) an alkyl (meth)acrylate or a vinyl ester of a saturated carboxylic acid and (3) an anhydride such as maleic anhydride or a (meth)acrylic acid or an epoxy such as glycidyl (meth)acrylate.

By way of examples of functionalized polyolefins of this latter type, mention may be made of the following copolymers, in which the ethylene preferably represents at least 60% by weight and in which the termonomer (the functional group) represents, for example, from 0.1 to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the above copolymers, the (meth)acrylic acid may be salified with Zn or Li.

The term “alkyl (meth)acrylate” in (B1) or (B2) denotes C₁ to C₈ alkyl methacrylates and acrylates, and may be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the aforementioned polyolefins (B1) may also be crosslinked by any suitable process or agent (diepoxy, diacid, peroxide, etc.); the term functionalized polyolefin also includes blends of the aforementioned polyolefins with a difunctional reactive agent such as a diacid, dianhydride, diepoxy, etc., which is capable of reacting with them or blends of at least two functionalized polyolefins able to react together.

The copolymers mentioned above, (B1) and (B2), may be copolymerized so as to form random or block copolymers and may have a linear or branched structure.

The molecular weight, the MFI index and the density of these polyolefins may also vary over a wide range, as those skilled in the art will appreciate. MFI is the abbreviation for Melt Flow Index. It is measured according to the ASTM 1238 standard.

Advantageously, the unfunctionalized polyolefins (B2) are chosen from polypropylene homopolymers or copolymers and any ethylene homopolymer or copolymer of ethylene and a comonomer of higher alpha-olefin type, such as butene, hexene, octene or 4-methyl-1-pentene. Mention may be made, for example, of high-density PP and PE, medium-density PE, linear low-density PE, low-density PE and very low-density PE. These polyethylenes are known to those skilled in the art as being produced by a “radical” process, by “Ziegler”-type catalysis or, more recently, by so-called “metallocene” catalysis.

Advantageously, the functionalized polyolefins (B1) are chosen from any polymer comprising alpha-olefin units and units carrying polar reactive functional groups such as epoxy, carboxylic acid or carboxylic acid anhydride functional groups. By way of examples of such polymers, mention may be made of ethylene/alkyl acrylate/maleic anhydride or ethylene/alkyl acrylate/glycidyl methacrylate terpolymers, such as the LOTADER® polymers from the Applicant, or maleic-anhydride-grafted polyolefins such as the OREVAC® polymers from the Applicant, as well as ethylene/alkyl acrylate/(meth)acrylic acid terpolymers. Mention may also be made of propylene homopolymers and copolymers grafted with a carboxylic acid anhydride and then condensed with polyamides or monoaminated polyamide oligomers.

The MFI of the polyamide and the MFIs of (B1) and (B2) may be chosen within a wide range; however, it is recommended, in order to facilitate the dispersion of (B), that the MFI of the polyamide be greater than that of (B).

For small proportions of (B), for example 10 to 15 parts, it is sufficient to use an unfunctionalized polyolefin (B2). The proportion of (B2) and (B1) in the (B) phase depends on the amount of functional groups present in (B1) and on their reactivity. Advantageously, (B1)/(B2) weight ratios ranging from 5/35 to 15/25 are used. It is also possible to use only a blend of polyolefins (B1) in order to obtain crosslinking.

According to a first preferred embodiment of the polyamide/polyolefin blend, the polyolefin (B) comprises (i) a high-density polyethylene (HDPE) and (ii) a blend of a polyethylene (C1) and a polymer (C2) chosen from elastomers, very low-density polyethylenes and ethylene copolymers, the (C1)+(C2) blend being cografted with an unsaturated carboxylic acid or an unsaturated carboxylic acid anhydride.

According to a variant of this first embodiment of the invention, the polyolefin (B) comprises (i) a high-density polyethylene (HDPE), (ii) a polymer (C2) chosen from elastomers, very low-density polyethylenes and ethylene copolymers, (C2) being grafted with an unsaturated carboxylic acid or an unsaturated carboxylic acid anhydride and (iii) a polymer (C′2) chosen from elastomers, very low-density polyethylenes and ethylene copolymers.

According to a second preferred embodiment of the polyamide/polyolefin blend, the polyolefin (B) comprises (i) polypropylene and (ii) a polyolefin which results from the reaction of a polyamide (C4) with a copolymer (C3) comprising propylene and an unsaturated monomer X, grafted or copolymerized.

According to a third preferred embodiment of the polyamide/polyolefin blend, the polyolefin (B) comprises (i) a polyethylene of the EVA, LLDPE, VLDPE or metallocene type and (ii) an ethylene/alkyl (meth)acrylate/maleic anhydride copolymer.

According to a fourth preferred embodiment of the polyamide/polyolefin blend, the polyolefin comprises two functionalized polymers containing at least 50 mol % of ethylene units and able to react in order to form a crosslinked phase. According to a variant, the polyamide (A) is chosen from blends of (i) a polyamide and (ii) a copolymer having PA-6 blocks and PTMG blocks and blends of (i) a polyamide and (ii) a copolymer having PA-12 blocks and PTMG blocks, the weight ratio of the amount of copolymer to the amount of polyamide being between 10/90 and 60/40.

With regard to the first embodiment, the proportions (by weight) are advantageously the following:
60 to 70% of polyamide,
5 to 15% of the cografted blend of (C1) and (C2),
the balance being high-density polyethylene.

With regard to the high-density polyethylene, its density is advantageously between 0.940 and 0.965 and the MFI between 0.1 and 5 g/10 min (190° C./2.16 kg).

The polyethylene (C1) may be chosen from the abovementioned polyethylenes.

Advantageously, (C1) is a high-density polyethylene (HDPE) having a density between 0.940 and 0.965. The MFI of (C1) is between 0.1 and 3 g/10 min (190° C./2.16 kg). The copolymer (C2) may, for example, be an ethylene-propylene elastomer (EPR) or ethylene/propylene/diene elastomer (EPDM). (C2) may also be a very low-density polyethylene (VLDPE) which is either an ethylene homopolymer or an ethylene/alpha-olefin copolymer. (C2) may also be a copolymer of ethylene with at least one product chosen from (i) unsaturated carboxylic acids, their salts and their esters, (ii) vinyl esters of saturated carboxylic acids and (iii) unsaturated dicarboxylic acids, their salts, their esters, their half-esters and their anhydrides. Advantageously (C2) is an EPR.

Advantageously, 60 to 95 parts of (C1) per 40 to 5 parts of (C2) are used.

The blend of (C1) and (C2) is grafted with an unsaturated carboxylic acid, that is to say (C1) and (C2) are cografted. It would not be outside the scope of the invention to use a functional derivative of this acid. Examples of unsaturated carboxylic acids are those having 2 to 20 carbon atoms, such as acrylic, methacrylic, maleic, fumaric and itaconic acids. The functional derivatives of these acids comprise, for example, anhydrides, ester derivatives, amide derivatives, imide derivatives and metal salts (such as alkali metal salts) of unsaturated carboxylic acids.

Unsaturated dicarboxylic acids having 4 to 10 carbon atoms and their functional derivatives, particularly their anhydrides, are particularly preferred grafting monomers. These grafting monomers comprise, for example, maleic, fumaric, itaconic, citraconic, allylsuccinic, cyclohex-4-ene-1,2-dicarboxylic, 4-methylcyclohex-4-ene-1,2-dicarboxylic, bicyclo[2.2.1]hept-5-ene-2,3-dicarboxylic and x-methylbicyclo[2.2.1]hept-5-ene-2,3-dicarboxylic acids and maleic, itaconic, citraconic, allylsuccinic, cyclohex-4-ene-1,2-dicarboxylic, 4-methylenecyclohex-4-ene-1,2-dicarboxylic, bicyclo-[2.2.1]hept-5-ene-2,3-dicarboxylic and x-methyl-bicyclo [2.2.1]hept-5-ene-2,2-dicarboxylic anhydrides. Advantageously maleic anhydride is used.

Various known processes can be used to graft a grafting monomer onto the blend of (C1) and (C2). For example, this may be achieved by heating the polymers (C1) and (C2) to a high temperature, about 150° C. to about 300° C., in the presence or absence of a solvent and with or without a radical initiator.

In the graft-modified blend of (C1) and (C2) obtained in the abovementioned manner, the amount of grafting monomer may be chosen appropriately, but it is preferably from 0.01 to 10% and better still from 600 ppm to 2%, with respect to the weight of cografted (C1)+(C2). The amount of grafted monomer is determined by assaying the succinic functional groups by FTIR spectroscopy. The MFI (190° C./2.16 kg) of the cografted (C1)+(C2) is 5 to 30 and preferably 13 to 20 g/10 min.

Advantageously, the cografted (C1)+(C2) blend is such that the MFI₁₀/MFI₂ ratio is greater than 18.5, MFI₁₀ denoting the melt flow index at 190° C. with a load of 10 kg and MFI₂ denoting the melt flow index with a load of 2.16 kg. Advantageously, the MFI₂₀ of the blend of the cografted polymers (C1) and (C2) is less than 24. MFI₂₀ denotes the melt flow index at 190° C. with a load of 21.6 kg.

With regard to the variant of the first embodiment, the proportions (by weight) are advantageously the following:
60 to 70% of polyamide,
5 to 10% of grafted (C2),
5 to 10% of (C′2),
the balance being high-density polyethylene.

Advantageously, (C2) is an EPR or an EPDM. Advantageously, (C′2) is an EPR containing 70 to 75% ethylene by weight.

With regard to the second embodiment, the proportions (by weight) are advantageously the following:
60 to 70% of polyamide,
20 to 30% of polypropylene,
3 to 10% of a polyolefin which results from the reaction of a polyamide (C4) with a copolymer (C3) comprising propylene and an unsaturated monomer X, grafted or copolymerized.

The MFI (230° C./2.16 kg) of the polypropylene is advantageously less than 0.5 g/10 min and preferably between 0.1 and 0.5. Such products are described in EP 647 681.

The grafted product of this second embodiment of the invention will now be described. Firstly (C3) is prepared, this being either a copolymer of propylene and an unsaturated monomer X, or a polypropylene onto which an unsaturated monomer X is grafted. X is any unsaturated monomer that can be copolymerized with propylene or grafted onto polypropylene and having a functional group capable of reacting with a polyamide. This functional group may, for example, be a carboxylic acid, a dicarboxylic acid anhydride or an epoxide. As examples of monomer X, mention may be made of (meth)acrylic acid, maleic anhydride and unsaturated epoxides such as glycidyl (meth)acrylate. Advantageously, maleic anhydride is used. With regard to the grafted polypropylenes, X may be grafted onto propylene homopolymers or copolymers, such as ethylene/propylene copolymers consisting predominantly (in moles) of propylene. Advantageously, (C3) is such that X is grafted. The grafting is an operation known per se.

(C4) is a polyamide or a polyamide oligomer. Polyamide oligomers are described in EP 342 066 and FR 2 291 225. The polyamides (or oligomers) (C4) are products resulting from the condensation of the abovementioned monomers. Polyamide blends may be used. It is advantageous to use PA-6, PA-11, PA-12, a copolyamide having PA-6 units and PA-12 units (PA-6/12) and a copolyamide based on caprolactam, hexamethylenediamine and adipic acid (PA-6/6,6). The polyamides or oligomers (C4) may have acid, amine or monoamine terminal groups. In order for the polyamide to have a monoamine terminal group, all that is required is to use a chain stopper of formula: 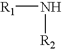
in which:
R₁ is hydrogen or a linear or branched alkyl group containing up to 20 carbon atoms;
R₂ is a linear or branched, alkyl or alkenyl group having up to 20 carbon atoms, a saturated or unsaturated cycloaliphatic radical, an aromatic radical or a combination of the above. The chain stopper may, for example, be laurylamine or oleylamine.

Advantageously, (C4) is a PA-6, a PA-11 or a PA-12. The proportion by weight of (C4) in (C3)+(C4) is advantageously between 0.1 and 60%. The reaction of (C3) with (C4) preferably takes place in the melt state. For example, it is possible to mix (C3) and (C4) in an extruder at a temperature generally between 230 and 250° C. The average residence time of the melt in the extruder may be between 10 seconds and 3 minutes and preferably between 1 and 2 minutes.

With regard to the third embodiment, the proportions (by weight) are advantageously the following:
60 to 70% of polyamide,
5 to 15% of an ethylene/alkyl (meth)acrylate/maleic anhydride copolymer,
the balance being a polyethylene of the EVA, LLDPE, VLDPE or metallocene type; advantageously the density of the LLDPE, VLDPE or metallocene polyethylene is between 0.870 and 0.925, and the MFI is between 0.1 et 5 (190° C./2.16 kg).

Advantageously, the ethylene/alkyl (meth)acrylate/maleic anhydride copolymers contain from 0.2 to 10% by weight of maleic anhydride and up to 40% and preferably 5 to 40% by weight of alkyl (meth)acrylate. Their MFIs are between 2 and 100 (190° C./2.16 kg). The alkyl (meth)acrylates have already been mentioned above. The melting point is between 80 and 120° C. These copolymers are commercially available. They are produced by radical polymerization at a pressure that may be between 200 and 2500 bar.

With regard to the fourth embodiment, the proportions (by weight) are advantageously the following:
40 to 95% of a polyamide,
60 to 5% of a blend of an ethylene/alkyl (meth)acrylate/maleic anhydride copolymer and of an ethylene/alkyl (meth)acrylate/glycidyl (meth)acrylate copolymer.

Advantageously, the ethylene/alkyl (meth)acrylate/maleic anhydride copolymers contain from 0.2 to 10% by weight of maleic anhydride and up to 40%, and preferably 5 to 40%, by weight of alkyl (meth)acrylate. Their MFIs are between 2 and 100 (190° C./2.16 kg). The alkyl (meth)acrylates have already been described above. The melting point is between 80 and 120° C. These copolymers are commercially available. They are produced by radical polymerization under pressure of between 200 and 2500 bar.

The ethylene/alkyl (meth)acrylate/glycidyl methacrylate copolymer may contain up to 40%, advantageously 5 to 40%, by weight of alkyl (meth)acrylate and up to 10%, preferably 0.1 to 8%, by weight of unsaturated epoxide.

Advantageously, the alkyl (meth)acrylate is chosen from methyl (meth)acrylate, ethyl acrylate, n-butyl acrylate, isobutyl acrylate and 2-ethylhexyl acrylate. The amount of alkyl (meth)acrylate is preferably from 20 to 35%. The MFI is advantageously between 5 and 100 g/10 min (190° C./2.16 kg) and the melting point is between 60 and 110° C. This copolymer can be obtained by radical polymerization of the monomers.

It is possible to add catalysts for accelerating the reaction between the epoxide and anhydride functional groups; among the compounds capable of accelerating the reaction between the epoxy functional group and the anhydride functional group, mention may be made in particular of:
tertiary amines, such as dimethyllaurylamine, dimethylstearylamine, N-butylmorpholine, N,N-dimethylcyclohexylamine, benzyldimethylamine, pyridine, dimethylamino-4-pyridine, methyl-1-imidazole, tetramethylethylhydrazine, 1a N,N-dimethylpiperazine, 1a N,N,N′,N′-tetramethyl-1,6-hexanediamine, a blend of tertiary amines having from 16 to 18 carbon atoms and known as dimethyltallowamine:
tertiary phosphines, such as triphenylphosphine;
zinc alkyldithiocarbamates; and
acids.

It would not be outside the scope of the invention if part of the ethylene/alkyl (meth)acrylate/maleic anhydride copolymer were to be replaced with an ethylene/acrylic acid copolymer or an ethylene/maleic anhydride copolymer, the maleic anhydride having been completely or partly hydrolysed. These copolymers may also comprise an alkyl (meth)acrylate. This part may represent up to 30% of the ethylene/alkyl (meth)acrylate/maleic anhydride copolymer.

Advantageously, the layer (2) made of a polyamide (A)/polyolefin (B) blend having a polyamide matrix is according to the first embodiment, that is to say that in which there is HPDE. Advantageously, the polyamide is PA-6 or PA-6/6,6 and preferably PA-.

With regard to the polyamide inner layer, the polyamide may be chosen from the polyamides mentioned for the outer layer. This polyamide may, like that of the outer layer, be plasticized by standard plasticizers such as N-butyl benzene sulphonamide (BBSA) and copolymers comprising polyamide blocks and polyether blocks. Advantageously, PA-12 or PA-11 is used. According to one particular embodiment, the polyamide of this inner layer is not plasticized.

According to one embodiment of the invention, the inner layer contains an electrically conducting material producing a surface resistivity of less than 10⁶ Ω.

As examples of electrical conductors, mention may be made of metals, metal oxides and carbon-based products. As examples of carbon-based products, mention may be made of graphite, carbon black aggregates, carbon fibres, carbon nanotubes and activated carbons. It would not be outside the scope of the invention to use several elements.

With regard to carbon black, the proportion is usually between 5 and 30 parts of black by weight per 100 parts of combination of polyamide and its plasticisers and other additives.

According to another embodiment of the invention, the inner layer (3) contains essentially no electrically conducting material and the tube includes a layer (3a) that adheres to the layer (3), this layer is made of a polyamide and contains an electrically conducting material producing a surface resistivity of less than 10⁶ Ω.

The polyamide of this layer (3a) may be chosen from the polyamides that can be used in the inner layer. It may be identical or different to the polyamide of the inner layer. It may also be chosen from the polyamides of the matrix of the layer (2).

These multilayer tubes may be cylindrical with a constant diameter or they may be annulate.

Conventionally, these tubes may include protective sheaths, specially made of rubber, in order to protect them from engine hot spots.

1. Multilayer tube comprising, in its radial direction from the outside inwards:
an outer layer (1) made of a polyamide chosen from PA-11, PA-12, aliphatic polyamides resulting from the condensation of an aliphatic diamine having from 6 to 12 carbon atoms and of an aliphatic diacide having from 9 to 12 carbon atoms, and 11/12 copolyamides having either more than 90% of 11 units or more than 90% of 12 units;
a tie layer;
a layer (2) made of a polyamide (A)/polyolefin (B) blend (2) having a polyamide matrix;
a tie layer;
an inner layer (3) made of a polyamide that is chosen from the same products as the outer layer and may be identical or different;
the layers being successive and adhering to one another in their respective contact zones.

2. Tube according to claim 1, in which the polyamide of the outer layer is PA-11 or PA-12.

3. Tube according to claim 1, in which the polyamide of the outer layer contains a plasticizer.

4. Tube according to claim 1, in which the tie layer is chosen from functionalized polyolefins, blends of a functionalized polyolefin with an unfunctionalized polyolefin, and copolyamides.

5. Tube according to claim 4, in which the copolyamides are a blend of a 6-rich copolyamide 6/12 and of a 12/rich copolyamide 6/12.

6. Tube according to claim 1, in which the polyolefin (B) of the layer (2) comprises (i) a high-density polyethylene (HDPE) and (ii) a blend of a polyethylene (C1) and a polymer (C2) chosen from elastomers, very low-density polyethylenes and ethylene copolymers, the (C1)+(C2) blend being cografted with an unsaturated carboxylic acid or an unsaturated carboxylic acid anhydride.

7. Tube according to claim 6, in which the proportions by weight are the following:
60 to 70 percent of polyamide,
5 to 15 percent of the cografter blend of (C1) and (C2),
the balance being high-density polyethylene.

8. Tube according to claim 1, in which the polyolefin (B) of the layer (2) comprises (i) a high-density polythelene (HDPE), (ii) a polymere (C2) chosen from elastomers, very low-density polyethylenes and ethylene copolymers, (C2) being grafted with an unsaturated carboxylic acid or an unsaturated carboxylic acid anhydride and (iii) a polymer (C′2) chosen from elastomers, very low-density polyethylenes and ethylene copolymers.

9. Tube according to claim 8, in which the proportions by weight are the following:
60 to 70 percent of polyamide,
5 to 10 percent of grafted (C2),
5 to 10 percent of (C′2),
the balance being high-density polyethylene.

10. Tube according to claim 1, in which the polyamide of the layer (2) is chosen from PA-6 and PA-6/6,6.

11. Tube according to claim 1, in which the polyamide of the inner layer is chosen from PA-11 and PA-12.

12. Tube according to claim 1, in which the inner layer contains an electrically conducting material, producing a surface resistivity of less than 10⁶ Ω.

13. Tube according to claim 1, in which the inner layer (3) contains essentially no electrically conducting material and the tube includes a layer (3a) that adheres to the layer (3), this layer is made of a polyamide and contains an electrically conducting material producing a surface resistivity of less than 10⁶ Ω.

14. Use of the tubes according to any one of the preceding claims for transporting petrol.
